(19) United States
(12) Patent Application Publication
(10) Pub. No.: US 2002/0157309 A1
(43) Pub. Date: Oct. 31, 2002

(54) Coconut fiber planting pot

(76) Inventor: Albert Wibmer, Reutlingen (DE)

Correspondence Address: Law Offices Renner Otto Boiselle & Sklar, The Keith Building 19th Floor, 1621 Euclid Avenue, Cleveland, OH, 44115-2191, US

(21) Appl. No.: 10/009,434

(22) PCT Filed: Mar. 1, 2001
(86) PCT No.: PCT/EP01/02289

(30) Foreign Application Priority Data
Apr. 28, 2000 (DE) 200 07 748.1

(51) Int. Cl. A01G 9/02

(52) U.S. Cl. 47/65.7

(57) ABSTRACT

In order to avoid the poor root penetration and poor decomposition characteristics of a planter (FIG. 1)—consisting essentially of a coconut fiber fleece material with a fiber binding agent—if a known airtight deep-drawn dry fleece with latex as the impregnating binding agent is used, the invention proposes as material an air-permeable dried wet fleece (FIG. 2) whose holes permit unimpeded penetration by roots and that can be biologically decomposed without problems.

The preferred material is a wet fleece where polyvinyl alcohol (PVA) fibers as binding agents were mixed with the coconut fibers during the manufacturing process; these PVA fibers are melted when the wet fleece is dried, shrinking primarily onto bonding spots where coconut fibers intersect.

### Description

The invention concerns a planter in accordance with the general term in claim 1 that defines the type.

A planter of this type is known whose material is an airtight deep-drawn dry fleece with latex as binding agent impregnating the coconut fibers. This relatively heavy thick-walled planter that is hard for the roots to penetrate and does not easily rot in the soil due to the latex is to be replaced by a better planter of the same type.

The planter that is proposed by the invention and avoids the disadvantages described above is characterized in claim 1. Its material, an air-permeable dried wet fleece, has the advantage that the growing roots of the plant planted in the planter can penetrate the planter wall almost unimpeded and spread in the soil surrounding the planter due to the numerous holes of various sizes of the fleece material, and that the planter can be biologically decomposed without problems by the microorganisms in the soil.

Appropriate design variants of the planter proposed by the invention are characterized in claims 2 and 3: An optimal solution involves a low percentage of the expensive PVA fibers used as binding agents in the fiber mixture because the air-permeability of the fleece material decreases with an increasing share of PVA. According to claim 4, the design of planter proposed by the invention may follow our own registered pattern DE 91 13 876 U1.

Below, the invention is explained in detail with the help of the design sample of the planter proposed by the invention shown in the drawing.

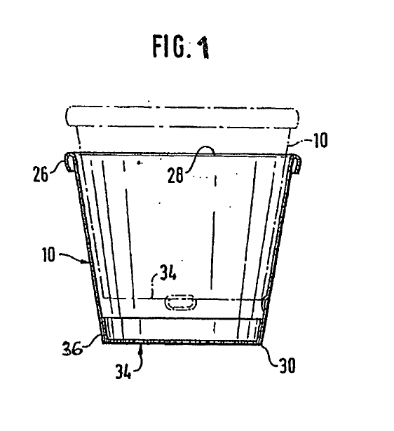

FIG. 1. shows a central vertical section through the design sample with a side view (dotted line)

and

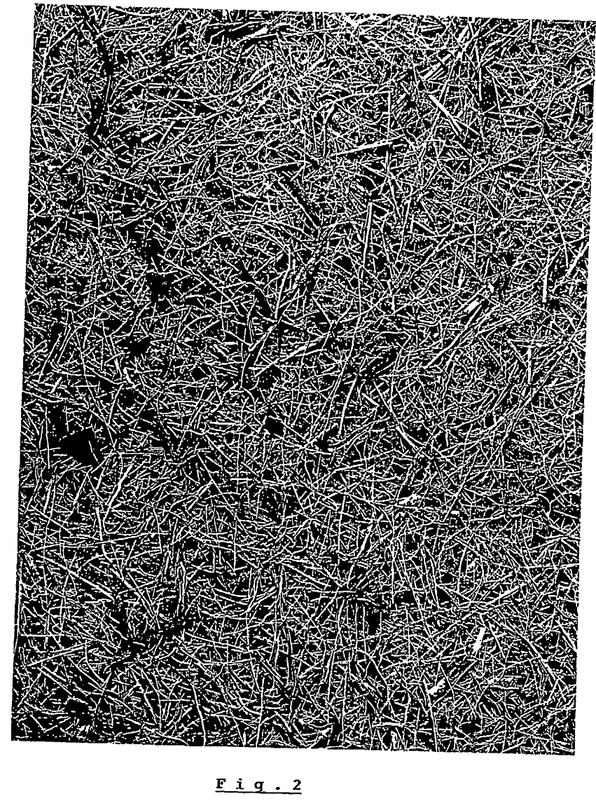

FIG. 2 shows a top view of a fleece material (sheet) that can be used for the manufacture of the design sample.

In the design sample, the planter proposed by the invention consists, as previously known (see DE 42 34 737 A1), of a shell 10 in the shape of a truncated cone with a flange 26 at its large opening 28 and a pan-shaped bottom 34 that has a tapered rim 36, pointing upward, that is glued into the small opening 30 of the shell.

The bottom 34 and the shell 10 consist of the same material, i.e., according to the invention, of an air-permeable dried wet fleece of coconut fibers to which polyvinyl alcohol (PVA) fibers had been added at a ratio by weight of 1: 10. The PVA fibers serve as binding agent in that they are melted when the wet fleece is dried, shrinking primarily onto bonding spots where coconut fibers intersect. Besides that, some PVA fibers retain their shape more or less unchanged; they serve as adhesive when the tight-fitting bottom 34 is glued to the shell 10.

Instead of the coconut fibers (that have previously been used as planter fibers) and the PVA fibers (that were previously known), other fibers may also be used for the manufacture of the fleece material as long as their relevant properties are essentially similar.

1. Planter (FIG. 1), essentially consisting of a coconut fiber fleece material with a fiber binding agent, characterized by the feature that the material is an air-permeable dried wet fleece (FIG. 2).

2. Planter according to claim 1, characterized by the feature that, during the manufacture of the wet fleece from coconut fibers, polyvinyl alcohol (PVA) fibers are added to the mixture as binding agents which are melted when the wet fleece is dried, shrinking primarily onto bonding spots where coconut fibers intersect.

3. Planter according to claim 2, characterized by the feature that the share of the polyvinyl alcohol fibers in the dispersed fiber mixture with coconut fibers amounts to between ten and twenty percent by weight.

4. Planter according to one of the claims 1 through 3, whose bottom (34) and shell (10) are made separately, are assembled in overlapping fashion, and are glued to each other in the area of overlap with the fiber binding agent under the influence of heat and pressure.
